(19) United States
(12) Patent Application Publication
(10) Pub. No.: US 2017/0373997 A1
(43) Pub. Date: Dec. 28, 2017

(54) REDUCING ALREADY VIEWED CONTENT IN SOCIAL NETWORKS

(71) Applicant: International Business Machines Corporation, Armonk, NY (US)

(72) Inventors: Yu Deng, Yorktown Heights, NY (US); Quang C. Duong, Tampa, FL (US); Jenny S. Li, Danbury, CT (US); Min Li, San Jose, CA (US); Theresa Tai, Hopewell Junction, NY (US)

(21) Appl. No.: 15/189,254

(22) Filed: Jun. 22, 2016

(51) Int. Cl. H04L 12/58; H04L 29/08

(52) U.S. Cl. CPC H04L 51/12; H04L 51/32; H04L 67/306

(57) ABSTRACT

An approach for reducing already viewed content in a social network, the approach including receiving a first content in a social network service and creating an identifier corresponding to the first content. The approach includes retrieving one or more identifiers associated with content previously viewed by a user and determining whether the user has previously viewed the first content. Responsive to determining that the user has previously viewed the first content, removing the first content from one or more social networking services accessed by the user.

### BACKGROUND OF THE INVENTION

The present invention relates generally to the field of social networking and more particularly to reducing the circulation of already viewed content in social networks.

Users of social networks enjoy sharing information. Social networking services such as Facebook®, LinkedIn®, and Twitter® capture large volumes of information from various sources that may be shared among users. Typically, a user sees an informative article, an amusing video, or other information that may be of interest to the user's friends and posts the article or video to a group of his or her friends. Similarly, another user with an overlapping group of friends sees the same article or video and posts it to his or her friends. Posting and re-posting of information on social networks occurs routinely, creating multiple posts of the same information or content that are received by a user from one or more friends. Additionally, the same content may be posted multiple times to the user by friends using multiple social networks, for example, if friends on both Facebook® and on LinkedIn® share the interesting article with the user, thus creating a duplication of the same shared social media content.

### SUMMARY

Embodiments of the present invention disclose a method, a computer program product, and a system for reducing already viewed content in a social network. The method includes receiving, by one or more computer processors, a first content in a social network service and creating an identifier corresponding to the first content. The method includes retrieving one or more identifiers associated with content previously viewed by a user and determining whether the user has previously viewed the first content. Responsive to determining that the user has previously viewed the first content, the method includes removing the first content from one or more social networking services accessed by the user.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of one example of a method to reduce already viewed content using a browser plug-in, in accordance with an embodiment of the present invention;

FIG. 3 is a flowchart depicting operational steps of one example of a method to reduce already viewed content using a social networking service plug-in, in accordance with an embodiment of the present invention; and

FIG. 4 is a block diagram depicting components of a computer system, in accordance with at least one embodiment of the present invention.

### DETAILED DESCRIPTION

Embodiments of the present invention recognize that a user may receive the same content from multiple friends within a social networking service. Furthermore, embodiments of the present invention recognize that the same content may be received in more than one social networking service. Embodiments of the present invention recognize that viewing or re-reading of previously viewed social networking shared content is unnecessary to many social networking service users. The elimination of previously viewed content shared in a social network, such as the same article received from multiple friends, is time consuming, especially when the same content is proliferated on many different social networks within various groups of friends and on many different social network services.

Embodiments of the present invention provide a method to reduce the circulation of already viewed content in social networks. Embodiments of the present invention create an identifier such as a hash value associated with each received content shared with a user in any of his or her social networks. Embodiments of the method provide a way to create an already viewed list that tracks an identifier corresponding to content such as shared articles, photographs, videos, comments, and news items in social networks viewed or acted upon by a user. Embodiments of the present invention provide a method to compare the identifier of the received content to an already viewed list of identifiers corresponding to content previously viewed by a user. Embodiments of the present invention prevent a user from viewing a display of already viewed content based, at least in part, on the comparison of an identifier of received content to identifiers present in an already viewed list for a user.

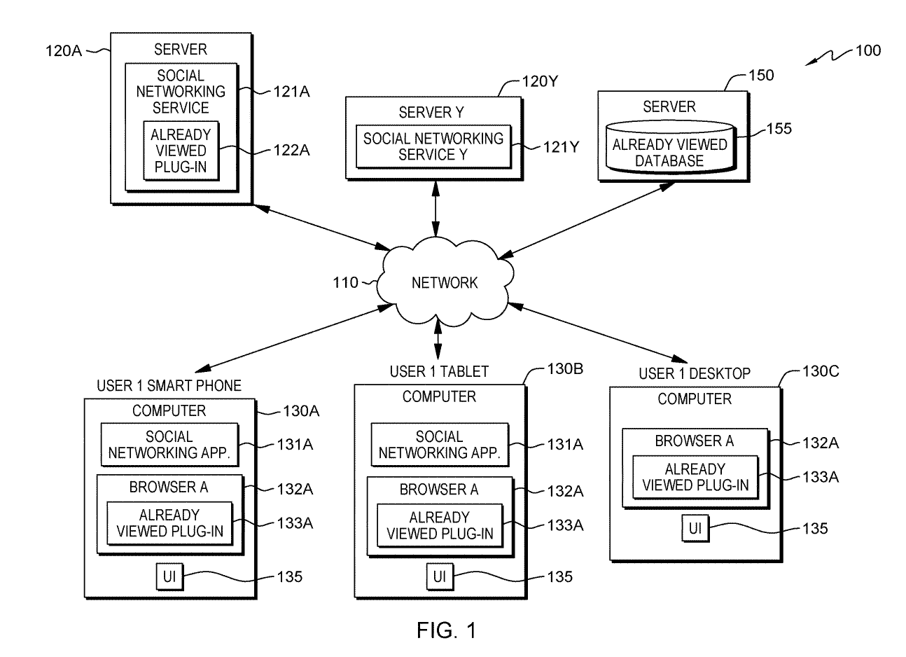

FIG. 1 is a functional block diagram illustrating a distributed data processing environment, generally designated 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

As depicted, distributed data processing environment 100 includes servers 120A-120Y (representing a variable number of servers, not limited to the number illustrated), server 150, and computers 130A, 130B, and 130C all interconnected over network 110. Network 110 can include, for example, a telecommunications network, a local area network (LAN), a virtual LAN (VLAN), a wide area network (WAN), such as the Internet, or a combination of the these, and can include wired or wireless connections. Network 110 can include one or more wired and/or wireless networks that are capable of receiving and transmitting data including receiving GPS signals or radio waves, voice, and/or video signals, including multimedia signals that include voice, data, and video information. In general, network 110 can be any combination of connections and protocols that will support communications between servers 120A-120Y, computers 130A-130C, server 150, and other computing devices (not shown) within distributed data processing environment 100.

Servers 120A-120Y and server 150 can each be a standalone computing device, an application server, a web server, a management server, a database server, or any other electronic device or computing system capable of receiving, sending, and processing data. In another embodiment, each of servers 120A-120Y and server 150 can be a laptop computer, a tablet computer, a netbook computer, a personal computer (PC), a desktop computer, a personal digital assistant (PDA), a smart phone, or any programmable electronic device capable of communicating with computers 130A-130C, and other computing devices (not shown) within distributed data processing environment 100 via network 110. In various embodiments, each of servers 120A-120Y and server 150 represents a computing system utilizing clustered computers and components (e.g., database server computers, application server computers, etc.) that act as a single pool of seamless resources such as used in a cloud-computing environment when accessed within distributed data processing environment 100.

Each of servers 120A-120Y hosts a respective social networking service such as social networking service 121A-121Y (representing a variable number of social networking services, not limited to the number illustrated). Servers 120A-120Y send and receive to and from computer 130A-130C information such as user generated posts and shared content in social networking services 121A-121Y respectively.

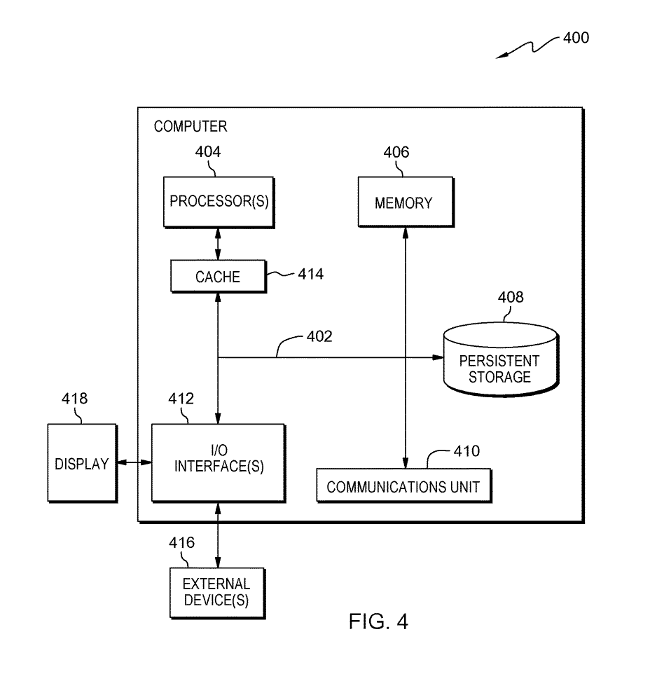

Server 150 includes already viewed database 155. Server 150 may send and receive information to and from each of servers 120A-120Y and computers 130A-130C. Server 150 receives information such as identifiers corresponding to already viewed content from already viewed plug-in 133A, already viewed plug-in 122A, and other already viewed plug-ins (not depicted in FIG. 1) from computers 130A-130C stored in already viewed database 155. Already viewed database 155 stores an already viewed list of identifiers corresponding to previously viewed content viewed by each user. In various embodiments, server 150 receives identifiers corresponding to content already viewed by a user from one or more servers 120A-120Y and/or one or more computers 130A-130C. Server 150 may receive identifiers associated with each user accessing or utilizing an already viewed plug-in (e.g., already viewed plug-in 133A and already viewed plug-in 122A in FIG. 1). Servers 120A-120Y and server 150 may include internal and external hardware components, as depicted and described in further detail with respect to FIG. 4.

Social networking services (SNS) 121A-121Y are each one of any known social networking service such as Facebook®, Instagram®, or the like. A social networking service such as SNS 121A is a platform to build social networks or social relations among people who share similar interests, activities, backgrounds or real-life connections. Each of SNS 121A-121Y provides users of the service with the ability to post and share information or content such as articles, comments, videos, links, photographs, and the like with friends and contacts in one or more of the user's social networks in SNS 121A-121Y. Each of SNS 121A-121Y stores and shares received content such as articles, videos, messages, links to blogs, and other similar information of interest to the users who are members of the respective service.

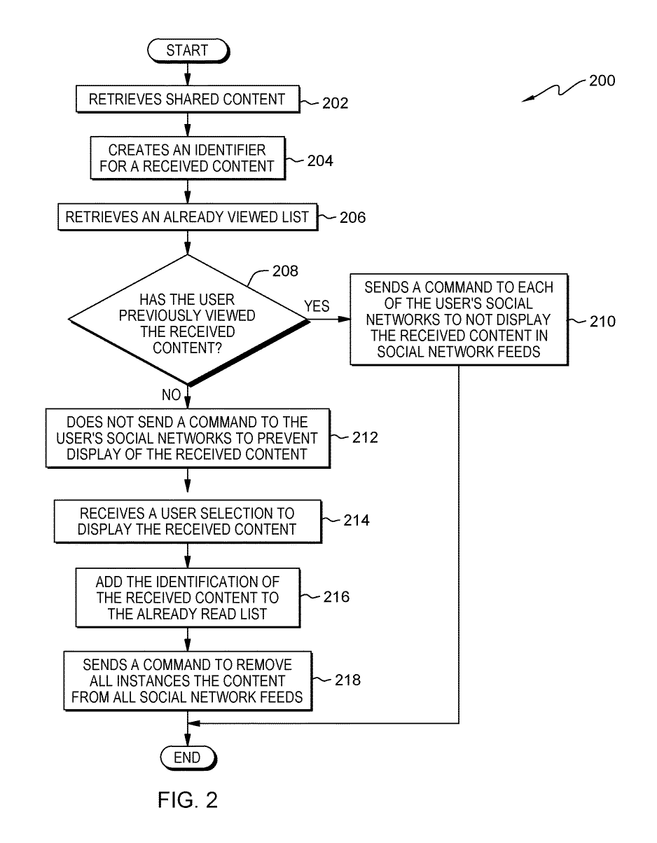

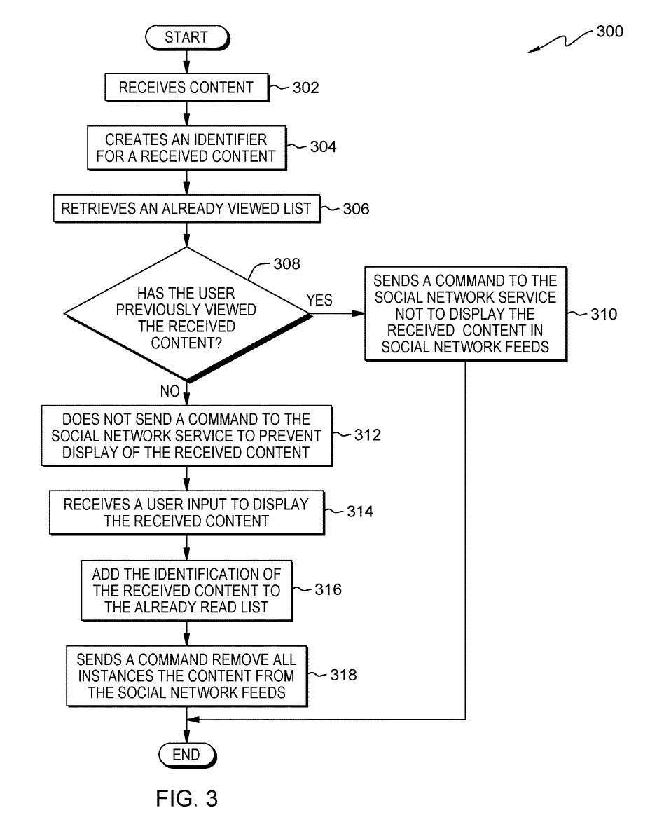

In various embodiments, an already viewed plug-in is a software extension to one or more social networking services (e.g., a software extension to SNS 121A-121Y such as already viewed plug-in 122A depicted in FIG. 1), a software extension to a mobile application (e.g., a plug-in or a software extension to a social networking app such as social networking app 131A) used in a mobile computer, and a software extension to one or more browsers (e.g., already viewed plug-in 133A on browser 132A) that provide the ability to prevent the display of content received in SNS 121A-121Y previously viewed by a user (e.g., user 1). An already viewed plug-in uses methods similar to those discussed with respect to FIGS. 2 and 3 to determine if a received content in SNS 121A-121Y is a content previously viewed or acted upon by a user (e.g., “liked” or commented on).

Already viewed plug-in 122A is a software extension or a plug-in to SNS 121A that prevents the display of content already viewed by a user such as user 1. Already viewed plug-in 122A automatically creates an identifier, for example using a hash function, for each content shared with a user in SNS 121A. Already viewed plug-in 122A retrieves an already viewed list of identifiers corresponding to each received content (e.g., from already viewed database 155 on server 150) that has been viewed or acted upon (e.g., “liked”) by user 1. Already viewed plug-in 122A compares the identifier corresponding to each received content to an already viewed list of identifiers corresponding to content previously viewed by user 1 to determine if a received content in SNS 121A is a content previously viewed by user 1 (e.g., when the identifier for a received content matches an identifier on the already viewed list for user 1). Already viewed plug-in 122A removes previously viewed content from SNS 121A. While depicted as already viewed plug-in 122A for SNS 121A, the function provided already viewed plug-in 122A is not limited SNS 121A. Already viewed plug-in 122A tracks the received content in each social network within a social network service (e.g., SNS 121A) to determine received content of high interest to the social network composed of a group of a user friends. The code and routines of already viewed plug-in 122A may be configured to function with any of SNS 121A-121Y to prevent a user from displaying previously viewed content in any social networking service such as SNS 121A-121Y that is utilizing a social networking service plug-in. For example, already viewed plug-in 122Y (not depicted in FIG. 1) is a software extension to SNS 121Y to prevent the display of already viewed content to user 1 using the method discussed later in FIG. 3.

Computers 130A-130C can each be one or more of a laptop computer, a tablet computer, a smart phone, or any programmable electronic device capable of communicating with various components and devices within distributed data processing environment 100, via network 110. In general, computers 130A-130C each represent any programmable electronic device or combination of programmable electronic devices capable of executing machine readable program instructions and communicating with other computing devices (not shown) within distributed data processing environment 100 via a network, such as network 110.

As depicted in FIG. 1, computers 130A-130C each include browser 132A with already viewed plug-in 133A, and user interface (UI) 135 in each of computers 130A-130C. Browser 132A is representative of a type of browser technology (e.g., a browser) that can be used for fetching and retrieving information from network 110. As depicted in FIG. 1, computer 130A is a smart phone for user 1, computer 130B is a tablet for user 1, and computer 130C is a desktop computer for user 1. Computers 130A-130C are depicted as an example of one embodiment of the present invention, but not limited to the types of devices or the number of devices depicted in FIG. 1). Computers 130A-130C may include internal and external hardware components, as depicted and described in further detail with respect to FIG. 4.

Social networking app 131A is an application or program that may be used by computers 130A-130C to access a social networking service, such as SNS 121A. For example, social networking app 131 on computer 130A (e.g., a smartphone used by user 1) may be a mobile application used to access SNS 121A. In various embodiments, an already viewed plug-in is included with social networking app 131. Already viewed plug-in 133A may be configured or added to social networking app 131A. An already viewed plug-in in a mobile application, such as social networking app 131A in computer 130A, is capable of providing the function to identify and prevent the display of content previously viewed by user 1 that is shared in SNS 121A. Additionally, an already viewed plug-in for accessing a social networking service may be configured to be included in social networking app for any of SNS 121A-121Y (e.g., social networking app 131Y not depicted in FIG. 1 for SNS 121Y) to which user 1 subscribes.

Browser 132A is a software application that may be used for retrieving, presenting, and traversing information resources on the Internet. Browser 132A may be, e.g., any known type of web browser. Additionally, computers 130A-130C may include more than one browser (e.g., computer 130A may include both browser 132A and one or more additional browsers). Based, at least in part, on a user input via UI 135, browser 132A may locate a social networking service such as SNS 121Y on server 120Y for user access. As depicted in FIG. 1, each instance of browser 132A includes already viewed plug-in 133A. In an embodiment, one or more browsers on a computing device does not include an already viewed plug-in.

Already viewed plug-in 133A is a software plug-in or an extension to browser 132A. In an embodiment, already viewed plug-in 133A is a plug-in or extension associated with a specific browser (i.e., the plug-in uses code consistent with the functionality of the browser). For example, already viewed plug-in 133A may include code and routines for an extension to browser 132A (e.g., already viewed plug-in 133A will not be supported by another browser technology or type, say browser type Z). In another embodiment, already viewed plug-in 133A is a cross-browser extension to browser 132A that is capable of functioning on more than one browser or browser technology. Development frameworks for cross-browser extensions use one set of code and/or one application programming interface (API) to provide functionality of a plug-in or an extension on more than one browser technology (e.g., a development framework allowing cross-bowser extensions operate on three different browsers).

Already viewed plug-133A retrieves and identifies, for example using a hash function, received content shared with user 1 in one or more of SNS 121A-121Y. Similar to already viewed plug-in 122A, the received content shared with user 1 may be any type of received content in SNS 121A-121Y such as an article in a newsfeed, a blog entry, or any type of shared user-generated content such as an article, a video, one or more photographs, a comment, and the like. Already viewed plug-in 133A tracks the displayed or already viewed content (e.g., articles, videos, etc.) provided by any of SNS 121A-121Y that are accessed using browser 132A and displayed on any computing device (e.g., computers 130A-130C) to user 1. Already viewed plug-in 133A creates an already viewed list of the identifiers such as hash values of already viewed content viewed or read by user 1 using one or more of SNS 121A-121Y through browser 132A. Already viewed plug-in 133A sends the identifiers corresponding to each viewed content to already viewed database 155 on server 150, which stores an already viewed list of identifiers corresponding to content viewed by user 1. Already viewed plug-in 133A updates the already viewed list when user 1 views additional content. Already viewed plug-in 133A adds the already viewed list for user 1 identifiers corresponding to the viewed content.

Already viewed plug-in 133A retrieves the already viewed list from already viewed database 155 to compare the respective identifiers corresponding to each received content to each identifier corresponding to content previously viewed by user 1 included on the already viewed list to determine if the received content has been viewed by user 1. Already viewed plug-in 133A generates a command preventing display of content corresponding to identifiers of previously viewed content to SNS 121A-121Y.

User interface 135 provides an interface for each user of computers 130A-130C with server 120A-120Y and other computing devices in distributed data processing environment 100 (not shown). In one embodiment, user interface 135 is a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In another embodiment, user interface 135 may also be mobile application software that provides an interface between the users of computers 130A-130C and server 120A-120Y. Mobile application software, or an “app,” is a computer program designed to run on smart phones, tablet computers and other mobile devices. User interface 135 enables computers 130A-130C to receive a user selection of information to share with other users or friends in a social network.

FIG. 2 is flowchart 200 depicting operational steps of one example of a method to reduce already viewed content using a browser plug-in, in accordance with an embodiment of the present invention. As depicted, FIG. 2 includes one example of the operational steps of a method to reduce the display of already viewed content in a social network to user 1 by executing already viewed plug-in 133A on browser 132A.

In step 202, already viewed plug-in 133A retrieves shared content. For example, when a user initiates already viewed plug-in 133A (e.g., by selecting a browser icon for browser 132A in a toolbar or menu) and provides user authentication or sign-in to one or more selected SNS 121A-121Y, then already viewed plug-in 133A retrieves from accessed SNS 121A-121Y shared content such as articles or videos. In an embodiment, already viewed plug-in 133A retrieves from an accessed social network service (e.g., one or more of SNS 121A-121Y) shared content received since the last access of the accessed social network service (e.g., one or more of SNS 121A-121Y) by already viewed plug-in 133A. For example, already viewed plug-in 133A retrieves from one or more of SNS 121A-121Y the shared articles, comments, and photographs received while already viewed plug-in 133A did not have access to SNS 121A-121Y (e.g., the user was not signed into SNS 121A-121Y and/or was not using already viewed plug-in 133A).

In various embodiments, already viewed plug-in 133A is configured to access each SNS 121A-121Y of which user 1 is a member of (e.g., saves in respective storage of computers 130A-130C account information for user 1 such as an account location, userid, account log-on and/or password for previously accessed SNS 121A-121Y). For example, already viewed plug-in 133A automatically accesses SNS 121A-121Y to which user 1 is a member to retrieve updates to content shared in one or more of the user 1's social networks (i.e., content received since user 1's last use of already viewed plug-in 133A). In various embodiments, already viewed plug-in 133A retrieves, from each of SNS 121A-121Y accessed by already viewed plug-in 133A, shared content received while already viewed plug-in 133A has been inactive. For example, when already viewed plug-in 133A is initiated, already viewed plug-in 133A automatically fetches or retrieves from accessible SNS 121A-121Y recently received content (i.e., content that has not yet been retrieved by already viewed plug-in 133A). In one embodiment, already viewed plug-in 133A retrieves content from each accessed SNS 121A-121Y on a determined frequency (e.g., every ten minutes).

In step 204, already viewed plug-in 133A creates an identifier for received content. In various embodiments, already viewed plug-in 133A creates an identifier using known hash functions for each shared content retrieved from any of SNS 121A-121Y accessed. For example, already viewed plug-in 133A uses a hash function to create a hash value, a hash code, or other similar hash function output to identify retrieved content received by user 1 in accessed SNS 121A-121Y. Already viewed plug-in 133A is not limited to the use of hash functions to create identifiers and may use other known methods of generating identifiers for content.

Already viewed plug-in 133A creates an identifier, for example a hash value or hash code, for each content shared with user 1 in SNS 121A-121Y accessed by the plug-in. In various embodiments, the identifier corresponds to the content of each post or notification of shared content and is specific to the content (e.g., the identifier is not based on a notification or a post but, on the content associated with the notification or post).

In step 206, already viewed plug-in 133A retrieves an already viewed list, for example from already viewed database 155 on server 150. An already viewed list is a list of identifiers (e.g., hash values) corresponding to content that has been displayed to user 1 for viewing, reading, or content that user 1 has acted upon (e.g., user 1 “liked” or comments on the content). In an embodiment, already viewed plug-in 133A uses known algorithms to track an amount of time a user views the content to determine if user 1 has read or viewed a displayed content (e.g., a video). When user 1 selects for viewing a shared content or comments on shared content, then the identifier corresponding to the viewed content is sent by already viewed plug-in 133A to already viewed database 155 for inclusion in the already viewed list for user 1.

In various embodiments, an already viewed list includes an identifier for any shared content viewed or acted upon by user 1 received from any already viewed plug-in (e.g., a browser plug-in, a mobile application plug-in, or a plug-in or extension to a social networking service). Examples of already viewed plug-ins sending identifiers of user-generated content previously viewed by user 1 to an already viewed list for user 1 stored in already viewed database 155 include browser already viewed plug-ins such already viewed plug-in 133A depicted in FIG. 1, server-side already viewed plug-ins such as already viewed plug-in 122A in SNS 121A depicted in FIG. 1, and already viewed plug-ins (not shown) for mobile applications such as social networking app 131A depicted in computer 130A of FIG. 1. In an embodiment, an already viewed list is stored in, and retrieved from, storage on computers 130A-130C in addition to storing in already viewed database 155 on server 150. An already viewed list stored in already viewed database 155 is specific to a user (e.g., user 1).

In decision step 208, already viewed plug-in 133A determines whether user 1 has previously viewed the received content. Already viewed plug-in 133A compares the identifier of the received content to identifiers on the retrieved already viewed list to determine if user 1 has already viewed the received content in a SNS 121A-121Y accessed with an already viewed plug-in. The already viewed list for user 1 may be retrieved from already viewed database 155 on server 150. Already viewed plug-in 133A determines whether any of the identifiers on the already viewed list corresponding to content previously viewed by user 1 match the identifier corresponding to the received content.

If already viewed plug-in 133A determines the identifier of the received content matches an identifier on the already viewed list, then the plug-in 133A determines the user has previously viewed the received content (yes branch of decision step 208). Already viewed plug-in 133A sends a command to SNS 121A-121Y to not display the received content in social network feeds (step 210). For example, already viewed plug-in 133A sends a command to remove the received content from SNS 121A-121Y feeds associated with user 1, such that the feeds do not include previously viewed content. In an embodiment, already viewed plug-in 133A uses facial or object recognition algorithms for determining if a received or shared photograph or video matches a stored photograph and video previously viewed by user 1 stored in a database (e.g., already viewed database 155).

If already viewed plug-in 133A determines that user 1 did not previously view the received content (no branch of decision step 208), then already viewed plug-in 133A does not send a command to prevent the display of the received content (step 212). When already viewed plug-in 133A determines the identifier of the received content does not match at least one of the plurality of identifiers on the already viewed list, the plug-in 133A determines user 1 has not yet viewed the received content in any SNS 121A-121Y accessed by an already viewed plug-in. If already viewed plug-in 133A determines that the user has not viewed the received content, then already viewed plug-in 133A does not send a command to any of SNS 121A-121Y to block the display of the received content.

In an embodiment, already viewed plug-in 133A includes a pre-set threshold number of times a notice of content is included in a social network service feed without an action such as a user request to display the content or “liking” the content. If already viewed plug-in 133A is configured with a threshold or pre-set number of views in social network service feed without user selection and a social network feed including the content has been viewed or appears in a social network feed for the threshold or pre-set number of times to the user without the user initiating a display, a comment, or other user action for the content, then already viewed plug-in 133A determines that the user is not interested in the content.

If already viewed plug-in 133A determines the user is not interested in the content, already viewed plug-in 133A sends a command to each of SNS 121A-121Y the user is a member of to remove the selection for the unacted upon content from all social network service feeds associated with user 1 (e.g., each of SNS 121A-121Y user 1 is associated with). For example, if the threshold is configured as ten displays of a content in a social network service feed without a user action (e.g., user 1 displays or comments on the content) and the user has looked at a feed of asocial network service (e.g., SNS 121A) ten times without viewing, then already viewed plug-in 133A sends a command to each of SNS 121A-121Y accessed by user 1 to remove the unacted upon content. The already viewed plug-in 133A removes the content determined not to be of interest to the user from each of the SNS 121A-121Y feeds associated with user 1 and sends the identifier corresponding to the content for inclusion on user 1's already viewed list (e.g., sends to already viewed database 155 on server 150 via network 110). In an embodiment, already viewed plug-in 133A tracks the number of times a user sees a content without an action by user 1 (e.g., no selection of the content by user 1) and when the number of times the user has seen the content without an action exceeds a pre-set threshold of times, then already viewed plug-in 133A sends a command to remove the content from SNS 121A-121Y associated with user 1.

In various embodiments, already viewed plug-in 133A includes the ability to track the number of comments and user actions on each content by each group of the user's friends (e.g., within each specific social network or configured group of friends). In this embodiment, when already viewed plug-in 133A determines that a pre-set number of times a user views or acts on (e.g., re-posts, or comments on a content) have occurred on a specific content within a social network (e.g., a group of friends), then already viewed plug-in 133A indicates to user 1 that significant interest in the content is occurring within one or more of user 1's social networks. For example, when users in a social network view or act upon a specific content sixty times and the pre-set number of times the user's in the social network view or act upon on a specific content is fifty times, already viewed plug-in 133A sends a command to the social network service to highlight the specific content to user 1. The highlighted content may be a highly relevant content to a social network of user 1's friends. In an embodiment, the specific content is highlighted in the social network feed for the social network finding the specific content highly relevant (i.e., the specific content is not highlighted in other social networks or other social network services). In an embodiment, already viewed plug-in 133A highlights the specific content determined of interest or relevant to a group of friends (e.g., to a social network) in all social networks in SNS 121A-121Y accessed by user 1. For example, already viewed plug-in 133A sends a command to each of SNS 121A-SNS 121Y user 1 is a member of to highlight the specific content determined to be interesting to one of user 1's social networks in SNS 121A. The highlight indicates to the user that the specific content is a highly relevant content within at least one social network (e.g., a group of the user's friends). Already viewed plug-in 133A may highlight in one or each of the identified user's social network feeds the specific relevant content by a color, a type font, an icon, or other known identification method.

In an embodiment, already viewed plug-in 133A highlights in each social network service feed, for any SNS 121A-121Y user 1 accesses, the specific content highly relevant to at one or more of user 1's social networks. For example, already viewed plug-in 133A highlights the specific content in user 1's social networks in accessed SNS 121A-121Y when the number of users viewing the specific content in at least one social network exceeds the pre-set number of views. In one embodiment, already viewed plug-in 133A highlights a display of specific content when a pre-set number of views or actions by members of any of user 1's social networks in accessed SNS 121A-121Y exceed a pre-set threshold. For example, if a picture is received one hundred times by user 1's social network, then the picture will be highlighted as a highly relevant or interesting content.

In various embodiments, any already viewed plug-in (e.g., a server-side already viewed plug-in or a mobile application already viewed plug-in) includes the ability to track interest (i.e., posts, views, and comments) within a group of the user's friends and to highlight in one or more of the user's SNS 121A-121Y feeds a high level of interest in a specific content.

In step 214, already viewed plug-in 133A receives user 1's selection to display the received content, or to otherwise interact with the content. When a user displays a content in one of SNS 121A-121Y accessed by already viewed plug-in 133A or takes an action such as commenting on a content, already viewed plug-in 133A adds the identifier corresponding to the displayed content to the already viewed list (step 216). For example, already viewed plug-in 133A sends the identifier corresponding to the viewed content to already viewed database 155 for inclusion in the already viewed list associated with user 1.

In response to receiving a user input from user 1 to display (or act upon) the received content, or otherwise receiving a notification of user interaction with the content, already viewed plug-in 133A sends a command to remove instances of the received content from one or more social network feeds (step 218) from SNS 121A-121Y accessed by user 1. Already viewed plug-in 133A sends a command to remove the display of the viewed, received content from any accessed social network feed associated with the user (i.e., from any SNS 121A-121Y that the user is a member of). In various embodiments, already viewed plug-in 133A performs steps 216 and 218 simultaneously. The method described in steps 202 through 218 provide the ability to reduce the circulation of previously viewed content shared in one or more social networks in SNS 121A-121Y accessed by user 1.

Already viewed plug-in 133A prevents user 1 from viewing the previously viewed content by retrieving an already viewed list from a database such as already viewed database 155 that receives updates of user 1 viewed content from multiple social networks in any of SNS 121A-121Y associated with user 1 when accessed with already viewed plug-in 133A. Already viewed plug-in 133A may be used from any computing device such as one or more of computers 130A-130C configured with the plug-in for a browser such as browser 132A. Furthermore, in various embodiments, already viewed plug-in 133A prevents user 1 from viewing previously viewed content accessed using any already viewed plug-in (e.g., a browser already viewed plug-in, a server-side already viewed plug-in for any of SNS 121A-121Y, or an already viewed plug-in for any mobile application) on any computing device (e.g., computers 130A-130C).

Already viewed list for user 1, stored in a database such as already viewed database 155, receives identifiers of user 1 viewed content from any already viewed plug-in, such already viewed plug-in discussed with reference to 133A. Any already viewed plug-in can compare the already viewed list of identifiers corresponding to content previously viewed by the user to an identifier corresponding to received or shared content. In various embodiments, already viewed plug-in 133A prevents the display to a user of previously viewed content in each SNS 121A-121Y feed associated with the user based on the comparison of identifiers. For example, an already viewed plug-in for a social networking app (e.g., social networking app 131A depicted in FIG. 1) prevents a user from viewing previously viewed user-generated content when one or more social networks are accessed using a social networking app. with an already viewed plug-in (not depicted in FIG. 1).

FIG. 3 is a flowchart 300 depicting operational steps of one example of a method to reduce already viewed content using a social networking service plug-in in accordance with an embodiment of the present invention. While the steps of a plug-in for a social networking service such as already viewed plug-in 122A in SNS 121A are discussed in reference to one social networking service (e.g., SNS 121A), the steps for an already viewed plug-in are not limited to use with SNS 121A and already viewed plug-in 122A but, may be applied with any already viewed plug-in corresponding to any other social networking service (e.g., any of SNS 121A-121Y). For example, an already viewed plug-in for SNS 121Y may be already viewed plug-in 122Y (not depicted in FIG. 1).

In step 302, already viewed plug-in 122A receives content shared with user 1 in SNS 121A. For example, already viewed plug-in 122A receives in near-real time each content shared with user 1 in any social network in SNS 121A. In an embodiment, already viewed plug-in 122A retrieves from SNS 121A each recently received shared content when user 1 initiates already viewed plug-in 122A by accessing SNS 121A.

In step 304, already viewed plug-in 122A creates an identifier for a received content. For example, already viewed plug-in 122A creates an identifier for the received content using the methods discussed in reference to step 204 in FIG. 2.

In step 306, using the methods previously described with reference to step 206 in FIG. 2, already viewed plug-in 122A retrieves an already viewed list. For example, already viewed plug-in 122A retrieves an already viewed list from already viewed database 155 on server 150 (depicted in FIG. 1). As previously discussed, the already viewed list is a list of identifiers corresponding to each content selected for display or otherwise acted upon by user 1.

In step 308, using the methods previously described with reference to decision step 208 in FIG. 2, in decision step 308, already viewed plug-in 122A determines whether user 1 has previously viewed the received content. Already viewed plug-in 122A determines whether the identifier corresponding to the received content matches an identifier in the retrieved already viewed list. In an embodiment, already viewed plug-in 122A using the method previously discussed with respect to already viewed plug-in 133A, highlights the specific content of interest or highly relevant to a social network of friends in each social network in SNS 121A.

When already viewed plug-in 122A determines user 1 has previously viewed the received content (yes branch decision 308), then already viewed plug-in 122A sends a command to SNS 121A not to display the received content in the feed of SNS 121A to the user (step 310). If the identifier of the received content matches an identifier in the already viewed list, then already viewed plug-in 122A determines that user 1 has previously viewed or acted upon the received content. If the content has been viewed by the user, the content is not provided to SNS 121A feed(s) to user 1. The SNS 121A feeds associated with user 1 will not include the received content.

However, if the user has not viewed the received content (no branch decision 308), then already viewed plug-in 122A does not send a command to SNS 121A to prevent the display of the received content (step 312) in SNS 121A feed to user 1. In this example, the received content will be available in SNS 121A feeds to user 1. As previously discussed, already viewed plug-in 122A determines the user has not viewed the received content when the identifier of the received content does not match any identifier in the already viewed list. Additionally, in an embodiment, using the methods discussed with respect to already viewed plug-in 133A, already viewed plug-in 122A tracks the number of times a user sees a content without an action by user 1 (e.g., no selection of the content by user 1) and when the number of times the user has seen the content without an action exceeds a pre-set threshold configured in the plug-in, then already viewed plug-in 122A removes from SNS 121A the content determined not to be of interest to user 1.

In step 314, already viewed plug-in 122A receives user 1 input to select or display the received content. User 1 on any computing device such as any one of computers 130A-130C elects to view the received content in SNS 121A. In various embodiments, already viewed plug-in 122A receives a notification of the selection from one or both of SNS 121A and computers 130A-130C.

In response to the display of the received content to user 1, already viewed plug-in 122A adds the identifier for the received content to the already viewed list (step 316). Already viewed plug-in 122A sends the identifier corresponding to the received content to already viewed database 155 for inclusion in the already viewed list for user 1.

Additionally, in response to the display of the received content to user 1, already viewed plug-in 122A sends a command to remove all instances of the content from the social network feeds (step 318) to user 1 in SNS 121A. For example, if the received content is a new stock market update that has been shared with user 1 by friends, John Smith, Sally Jones, John Doe, and Jane Doe, then when user 1 displays the content or the new stock market update from Jane Doe all other instances of the new stock market update shared from John Smith, Sally Jones, and John Doe are removed from user 1's social network feeds in SNS 121A. Already viewed plug-in 122A sends the identifier corresponding to the new stock market update to already viewed database 155 for inclusion on user 1's user's already viewed list.

As discussed with reference to the steps associated with flowchart 200 and flowchart 300, an already viewed plug-in may be a software plug-in extending the function of any browser, mobile application, or server-side program or service such as SNS 121A-121Y. An already viewed plug-in uses an already viewed list associated with a user retrieved from a database such as already viewed database 155 to determine if a user has previously viewed a shared content in one or more SNS 121A-121Y.

FIG. 4 is block diagram 400 depicting components of a computer system in accordance with at least one embodiment of the present invention. As depicted, FIG. 4 depicts the components of a computer system, which is an example of a system such as server 120A-120Y, server 150, or a system such as computers 130A-130C within distributed data processing environment 100, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Servers 120A-120Y, server 150, and computers 130A-130C can include processor(s) 404, cache 414, memory 406, persistent storage 408, communications unit 410, input/output (I/O) interface(s) 412, and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention are stored in persistent storage 408 for execution and/or access by one or more of the respective processor(s) 404 via cache 414. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is part of persistent storage 408.

Communications unit 410, in these examples, provides for communications with other data processing systems or devices, including resources of servers 120A-120Y, server 150, computers 130A-130C, and other computing devices not shown in FIG. 1. In these examples, communications unit 410 includes one or more network interface cards. Communications unit 410 may provide communications with either or both physical and wireless communications links. Program instructions and data used to practice embodiments of the present invention may be downloaded to persistent storage 408 through communications unit 410.

I/O interface(s) 412 allows for input and output of data with other devices that may be connected to server 120A-120Y and computers 130A-130C. For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media, for example, devices such as thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a computer monitor. Display 418 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application, or technical improvement over technologies found in the marketplace, or to enable others of ordinary skill in the art to understand the embodiments disclosed herein.

What is claimed is:

1. A method comprising:
receiving, by one or more computer processors, first content in a social network service;
creating, by the one or more computer processors, an identifier corresponding to the first content;
retrieving, by the one or more computer processors, one or more identifiers associated with content previously viewed by a user;
determining, by the one of more computer processors, whether the user has previously viewed the first content; and
responsive to determining that the user has previously viewed the first content, removing, by the one or more computer processors, the first content from one or more social networking services accessed by the user.

2. The method of claim 1, wherein creating the identifier further comprises using a hash function to identify the first content.

3. The method of claim 1, wherein determining if the user has previously viewed the first content further comprises:
comparing, by the one or more computer processors, the identifier corresponding to the first content to the one or more identifiers associated with content previously viewed by the user; and
responsive to determining that the identifier corresponding to the first content matches at least one of the one or more identifiers associated with content previously viewed by the user, determining, by the one or more computer processors, that the user has previously viewed the first content.

4. The method of claim 1, further comprising:
responsive to determining the user has not previously viewed the first content, displaying, by the one or more computer processors, the first content to the user in each of the one or more social networking services accessed by the user.

5. The method of claim 4, further comprising:
receiving, by the one or more computer processors, a user input to interact with the first content;
storing, by the one or more computer processors, the identifier corresponding to the first content with the one or more identifiers associated with content previously viewed by the user; and
responsive to storing the identifier corresponding to the first content, removing, by the one or more computer processors, the first content from each of the one or more social networking services accessed by the user.

6. The method of claim 1, wherein the method of claim 1 is performed by a plug-in.

7. The method of claim 6, wherein the plug-in is at least one of a plug-in to a social networking service, a plug-in to a browser, or a plug-in to a mobile application in a mobile computer.

8. The method of claim 1, further comprising:
responsive to determining the user has not previously viewed the first content, tracking, by the one or more computer processors, a number of times that the first content appears in one or more feeds viewed by the user and the user does not interact with the first content;
determining, by one or more computer processors, whether the number of times the first content appears in the one or more feeds viewed by the user exceeds a pre-set threshold number of times;
in response to determining that the number of times exceeds the pre-set threshold number of times, removing, by one or more computer processors, the first content from each of the one or more social networking services accessed by the user; and
storing, by one or more computer processors, the identifier corresponding to the first content with the one or more identifiers associated with content previously viewed by a user.

9. The method of claim 1, wherein determining whether the user has previously viewed the first content further comprises:
tracking, by one or more computer processors, a number of times the first content is shared by one or more members of a social network accessed by the user;
determining, by one or more computer processors, whether the number of times the first content is shared exceeds a pre-set number of times; and
responsive to determining the number of times the first content is shared exceeds the pre-set number of times, highlighting, by one or more computer processors, the first content to indicate to the user the first content is highly relevant to the one or more members of the social network.

10. A computer program product comprising:
one or more computer readable storage media and program instructions stored on the one or more computer readable storage media, the program instructions executable by a processor, the program instructions comprising instructions for:
receiving, by one or more computer processors, first content in a social network service;
creating, by the one or more computer processors, an identifier corresponding to the first content;
retrieving, by the one or more computer processors, one or more identifiers associated with content previously viewed by a user;
determining, by the one of more computer processors, whether the user has previously viewed the first content; and
responsive to determining that the user has previously viewed the first content, removing, by the one or more computer processors, the first content from one or more social networking services accessed by the user.

11. The computer program product of claim 10, wherein creating the identifier further comprises using a hash function to identify the first content.

12. The computer program product of claim 10, wherein determining if the user has previously viewed the first content further comprises:
comparing, by the one or more computer processors, the identifier corresponding to the first content to the one or more identifiers associated with content previously viewed by the user; and
responsive to determining that the identifier corresponding to the first content matches at least one of the one or more identifiers associated with content previously viewed by the user, determining, by the one or more computer processors, that the user has previously viewed the first content.

13. The computer program product of claim 10, further comprising:
responsive to determining the user has not previously viewed the first content, displaying, by the one or more computer processors, the first content to the user in each of the one or more social networking services accessed by the user.

14. The computer program product of claim 13, further comprising:
receiving, by the one or more computer processors, a user input to interact with the first content;
storing, by the one or more computer processors, the identifier corresponding to the first content with the one or more identifiers associated with content previously viewed by the user; and
responsive to storing the identifier corresponding to the first content, removing, by the one or more computer processors, the first content from each of the one or more social networking services accessed by the user.

15. The computer program product of claim 10, wherein the operations are performed by a plug-in.

16. The computer program product of claim 15, wherein the plug-in is at least one of a plug-in to a social networking service, a plug-in to a browser, or a plug-in to a mobile application in a mobile computer.

17. A computer system comprising:
one or more computer processors;
one or more computer readable storage media; and
program instructions stored on the one or more computer readable storage media for execution by at least one of the one or more processors, the program instructions comprising instructions for:
receiving, by one or more computer processors, first content in a social network service;
creating, by the one or more computer processors, an identifier corresponding to the first content;
retrieving, by the one or more computer processors, one or more identifiers associated with content previously viewed by a user;
determining, by the one of more computer processors, whether the user has previously viewed the first content; and
responsive to determining that the user has previously viewed the first content, removing, by the one or more computer processors, the first content from one or more social networking services accessed by the user.

18. The computer system of claim 17, wherein determining if the user has previously viewed the first content further comprises:
comparing, by the one or more computer processors, the identifier corresponding to the first content to the one or more identifiers associated with content previously viewed by the user; and
responsive to determining that the identifier corresponding to the first content matches at least one of the one or more identifiers associated with content previously viewed by the user, determining, by the one or more computer processors, that the user has previously viewed the first content.

19. The computer system of claim 17, wherein the operations of the system use a plug-in to at least one of a browser, a social networking service, or a mobile application.

20. The computer system of claim 17, further comprising:
responsive to determining the user has not previously viewed the first content, tracking, by the one or more computer processors, a number of times that the first content appears in one or more feeds viewed by the user and the user does not interact with the first content;
determining, by one or more computer processors, whether the number of times the first content appears in the one or more feeds viewed by the user exceeds a pre-set threshold number of times;
in response to determining that the number of times exceeds the pre-set threshold number of times, removing, by one or more computer processors, the first content from each of the one or more social networking services accessed by the user; and
storing, by one or more computer processors, the identifier corresponding to the first content with the one or more identifiers associated with content previously viewed by a user.
